(19) United States
(12) Patent Application Publication
(10) Pub. No.: US 2003/0095339 A1
(43) Pub. Date: May 22, 2003

(54) Projection aligner

(75) Inventors: Yoshinori Kobayashi, Tokyo (JP); Masato Hara, Tokyo (JP); Shigetomo Ishibashi, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/298,945

(22) Filed: Nov. 19, 2002

(30) Foreign Application Priority Data
Nov. 20, 2001 (JP) 2001-354759

(51) Int. Cl. G03B 27/42; G02B 17/00

(52) U.S. Cl. 359/726; 355/53

(57) ABSTRACT

A projection aligner transfers an image of a mask onto an object. The mask and the object are substantially parallel with each other. The project aligner has a light source that emits light in a predetermined direction. The light is directed toward the object through the mask. A deflection unit including first and second mirrors inserted in an optical path of the light directed from the mask to the object. An angle formed by the first and second mirrors of the deflection unit is greater than 180 degrees. The light reflected by the first mirror passes through the lens unit, is reflected by a mirror unit, and is deflected by the second mirror to the object. Optical paths of the light from the mask to the first mirror and the light from the second mirror to the object are substantially parallel with each other, and the deflection unit is driven in the predetermined direction.

### BACKGROUND OF THE INVENTION

The present invention relates to a projection aligner that projects a pattern formed on a mask onto an object to be exposed, transferring the pattern to the object.

Projection aligners have been used to form wiring patterns of PCBs (Printed Circuit Boards), transparent electrodes of LCD (Liquid Crystal Display) panels and the like.

A typical projection aligner is provided with (a) a high-power light source such as an ultra-high-pressure mercury-vapor lamp which is provided to emit a light beam toward a mask, and (b) a projecting optical system to project the light beam passed through the mask so that an object, on which photosensitive material is applied, is exposed to the beam passed through the mask and an image of a pattern formed on the mask is transferred. The object to be exposed to the light may be a substrate of the PCB, an ICB (Integrated Circuit Board), LCD panel and the like.

In such a projection aligner, the light source is typically arranged at a fixed position, and the mask and the object (i.e., the substrate) are moved synchronously with each other in the same direction so that the pattern formed on the mask is transferred onto the entire area of the object. For forming a pattern such as a transparent electrode of the LCD panel with a high precision, the mask and the object should be aligned with high precision at about an order of 0.5 μm. As such, the conventional projection aligner requires a driving mechanism that is capable of driving the mask and the object with high precision by a relatively large amount corresponding to the size of the mask and the object, which requires a relatively high manufacturing cost.

### SUMMARY OF THE INVENTION

The present invention is advantageous in that a projection aligner capable of forming a wiring pattern of a PCB, a transparent electrode of an LCD panel or the like with high accuracy can be provided at a relatively low cost.

According to an aspect of the invention, there is provided a projection aligner for transferring an image of a mask having a predetermined pattern onto an object to be exposed, the projection aligner is provided with a light source unit that emits a plurality of light beams to the mask to illuminate predetermined areas of the mask, a plurality of first mirrors that deflect the light beams emitted by the light source and passed through the predetermined area of the mask, a plurality of lens units, the light beams deflected by the first mirrors being incident on the lens units, respectively, a plurality of reflectors that reflect the light beams passed through the lens units, respectively, the reflected light beams being incident on the plurality of lens units, respectively, a plurality of second mirrors that deflect the light beams reflected by the reflectors and passed through the lens units, respectively, the light beams deflected by the second mirrors being incident on the object, the object being arranged in parallel with the mask, an image being formed by the light beams on the object, and plurality of mirror driving mechanisms that respectively move the first and second mirrors such that a positional relationship between beam incident points on the mask and beam incident points on the object is changed.

With this, construction, the movements of the first and second mirrors change the position of the image formed on the object in a direction of an optical axis of the lens units. Accordingly, the positional deviation between the mask and the object can be compensated by controlling the mirror driving mechanisms, which eliminates the need for adjusting the movement of the mask and the object with high precision.

Generally, the weight of the first and second mirrors is considered to be much less than the weight of the mask and/or the object and a stroke required for the movement of the first and second mirrors maybe a few millimeters. Accordingly, a simple and low-cost mechanism having high precision can be used as each of the mirror driving mechanisms. Therefore, high precision driving mechanisms for moving the mask and the object within a large stroke corresponding to the size of the mask and the object are not required, which reduces the cost of the device. A direction of the movements of the mask and the object is defined as a scanning direction.

In a particular case, if the first and second mirrors are integrated in a single member, each of the mirror driving mechanisms may move a single component, which simplifies a structure of each of the mirror driving mechanisms. Preferably, the mirror has a shape of a triangle prism whose section is an isosceles right triangle, and the first and second plane mirrors are formed on the side surfaces forming the right angle.

Further, when the reflectors include roof mirrors, reflection surfaces of each of which are arranged perpendicular to the mask, an erect image of the pattern on the mask is formed on the object, which enables to arrange a plurality of the light sources and the projecting optical systems in a direction perpendicular to the scanning direction. In such a case, since a continuous pattern on the mask that is too large to be projected by a single projecting optical system can be simultaneously projected by a plurality of imaging optical systems, a large pattern can be formed on the object by a single scan. Use of a right-angle prism that internally reflects the light beam by rectangular surfaces thereof produces the same effect as the roof mirror.

Still further, the projection aligner may further include a first deviation detector that detects a deviation length of the object with respect to the mask in a direction of the optical axis of the lens unit, and a controller that determines moving amounts of the first and second mirrors based on an output from the first deviation detector, the controller controlling the mirror driving mechanism to move the first and second mirrors by the determined moving amounts.

The first deviation detector preferably detects the deviation length by measuring a distance from the incident position of the light beam on the mask to an index mark formed on the mask and a distance from the incident position of the light beam on the object to an index mark formed on the object.

The projection aligner may further include a mask-driving mechanism for moving the mask, an object-driving mechanism for moving the object synchronously with the mask, a second deviation detector that detects a deviation length of the object with respect to the mask in a moving direction thereof during operations of said mask-driving mechanism and said object-driving mechanism, and a controller that determines moving amounts of said first and second mirrors based on an output from said second deviation detector, said controller controlling said mirror driving mechanism to move said first and second mirrors by the determined moving amounts.

This construction allows aligning the mask with the object even if the mask is not moved completely synchronous with the object due to error of precision of the driving mechanism.

In a particular case, the light source unit includes a plurality of light sources that emit a plurality of light beams, respectively. Alternatively or optionally, the light source unit may include a single light source that emit a light beam, and a beam splitting element that splits the light beam into a plurality of light beams.

According to a further aspect of the invention, there is provided a projection aligner for transferring an image of a mask having a predetermined pattern onto an object to be exposed, the mask and the object being substantially parallel with each other. The project aligner is provided with a light source unit that emits at least one light beam in a predetermined direction, the light being directed toward the object through the mask, first and second mirrors inserted in an optical path of the at least one light beam directed from the mask to the object, an angle formed by the first and second mirrors being greater than 180 degrees, a lens unit on which the light reflected by the first mirror is incident, a mirror unit that reflects the at least one light beam reflected by the first mirror and passed through the lens unit back to the lens unit, the second mirror deflecting the at least one light beam reflected by the mirror unit and passed through the lens unit to the object, an optical path of the at least one light beam from the mask to the first mirror and an optical path of the at least one light beam from the second mirror to the object being substantially parallel with each other, and a driving mechanism that drives the first and second mirrors in the predetermined direction.

According to a further aspect of the invention, there is provided a projection aligner for transferring an image of a mask having a predetermined pattern onto an object to be exposed. The projection aligner further includes a light source that emits a light beam to the mask to illuminate a predetermined area of the mask, the light beam passed through the mask being directed toward the object, first mirror and second mirror inserted in an optical path of the light beam directed from the mask to the object, the first and second mirror forming an angle of greater than 180 degrees, a lens unit, the light beam deflected by said first mirror being incident on said lens unit, a reflector that reflects the light beam reflected by said first mirror and passed through said lens unit being reflected by said second mirror and incident on the object, and a mirror driving mechanism that moves said first and second mirrors such that a positional relationship between a beam incident point on the mask and a beam incident point on the object is changed.

Preferably, the reflector may include a roof mirror.

### DESCRIPTION OF THE ACCOMPANYING DRAWINGS

FIG. 1 schematically shows a configuration of a projection aligner according to an embodiment of the present invention;

FIG. 2 schematically shows a part of the configuration of a projection aligner shown in FIG. 1;

FIG. 3 shows an arrangement of the elements of the projection aligner before compensation;

FIG. 4 shows an arrangement of the elements of the projection aligner after the compensation; and

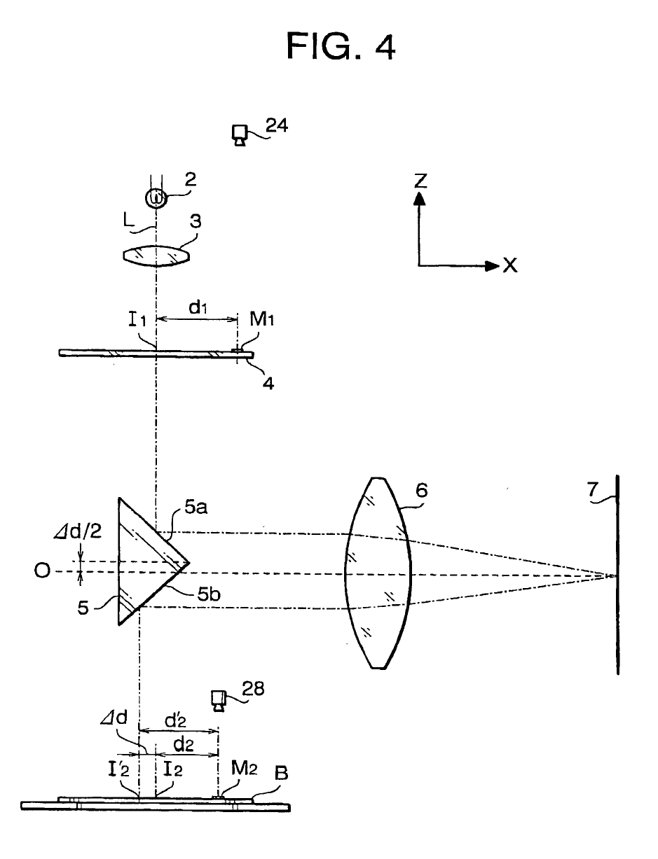

FIG. 5 schematically shows a configuration of a projection aligner according to a modification of the embodiment.

### DESCRIPTION OF THE EMBODIMENTS

A projection aligner according to an embodiment of the invention will be described with reference to the accompanying drawings.

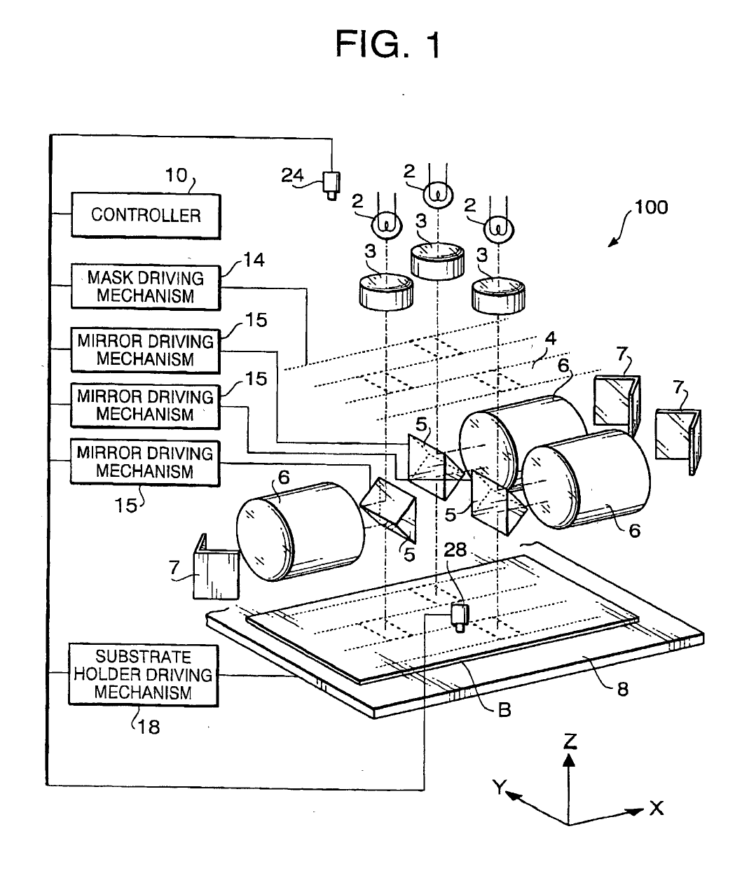

FIG. 1 schematically shows a configuration of a projection aligner 1 according to an embodiment of the invention. The projection aligner 1 has a light source unit 100, which includes a plurality of light sources 2 and a plurality of collimating lenses 3, a mask 4, a plurality of mirrors 5, a plurality of lens units 6, a plurality of roof mirrors 7 and a substrate holder 8. The substrate holder 8 carries a substrate B as an object to be exposed. The substrate holder 8 and the mask 4 are driven to move synchronously in the same direction for scanning. As shown in FIG. 1, the beams emitted by the light sources 2, pass through the collimating lenses 3, pass through the mask 4, reflected by the mirrors 5, pass through the lens units 6, reflected by the roof mirrors 7, pass through the lens units 6 again, reflected by the mirrors 5, respectively, and are incident on the substrate B.

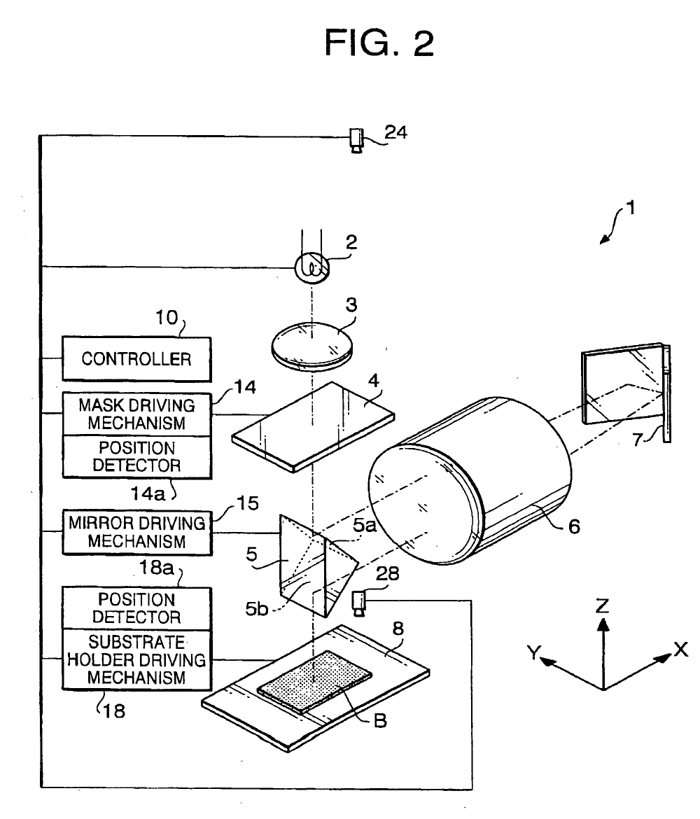

FIG. 2 shows a part of the projection aligner shown in FIG. 1. In FIG. 2, components related to one beam are extracted for the sake of explanation. Since the components related to the plurality of beams are functionally the same, the projection aligner will be described with reference to FIG. 2.

In the following description, a direction in which the mask 4 and the substrate holder 8 move is referred to as an X-axis direction. Further, a Y-axis is defined, which is on a plane parallel to the mask 4 and perpendicular to the X-axis, and a Z-axis is defined as a direction of a light beam emitted from the light source 2 and incident on the substrate B. According to the embodiment, the light beam is perpendicularly incident on the surface of the substrate B. A direction from the mirror 5 toward the lens unit 6 will be defined as a positive direction along the X-axis. A direction from the substrate holder 8 toward the mask 4 is defined as a positive direction along the Z-axis. The directions and the senses thereof are indicated in each drawing.

The collimating lens 3, the mirror 5, the lens unit 6 and the roof mirror 7 constitute a projecting optical system. In FIG. 1, only three light sources 2 are included in the light source unit 100. It should be noted that, in an actual projection aligner, a plurality of light sources and corresponding projecting optical systems are provided and arranged in the Y-axis direction. With this configuration, a large pattern can be formed on the object by a single scan (i.e., only by moving the substrate B and the mask 4 in one-way).

The wavelength and output power of the light source 2 are determined such that the photosensitive material applied on the substrate B is sensitive to the light. An example of such a light source 2 is an ultra-high-pressure mercury-vapor lamp. Each of the light sources 2 irradiates an area having a predetermined width (in the Y-axis direction) through the collimating lens 3. As the mask 4 moves in the X-axis direction relative to the light sources 2, rectangular areas each having the predetermined width are scanned by the beams, respectively. The light sources 2 and the collimating lenses 3 are arranged such that the areas on the mask 4 simultaneously exposed to light beams are closely adjacent with each other in the Y-axis direction. As shown in FIG. 1, the adjoining areas on the mask 4 exposed to the light beams are spaced in the X-axis direction due to an alternating arrangement of the projection optical systems.

The light beams transmitted through the mask 4 are reflected by the mirrors 5. Each of the mirror 5 has a shape of a triangular prism whose cross section on an X-Z plane is a right-angled isosceles triangle. The mirror 5, or the triangular prism shape has a first surface 5a and a second surface 5b forming a right angle, both of which are plane mirrors (hereinafter they are referred to as first plane mirror 5a and second plane mirror 5b). The mirror 5 is arranged such that a normal to each of the first and second plane mirrors 5a and 5b forms 45 degrees with respect to the X-axis, and a ridge line formed by the first and second plane mirrors 5a and 5b extends in the Y-axis direction. It should be noted that the normal to each of the first and second plane mirrors 5a and 5b needs not be limited to this angle. As understood from FIGS. 1 and 2, as far as the beam passed through the mask 4 is deflected to and incident on the lens unit 6, the inclination of the mirror may be determined arbitrarily. Similarly, as far as the beam emerging from the lens unit 6 is deflected to the substrate B, the inclination of the second plane mirror 5b may be determined arbitrarily. As will be described, a position where the beam is incident on the substrate B with respect to a position where the beam incident on the mask, in the X-axis direction, can be varied by moving the first and second mirrors 5a and 5b in the Z-axis direction. The ratio of a shifting amount of the beam incident position on the object in the X-axis direction to the moving amount of the mirror 5 in the Z-axis direction may be changed by varying the inclination of the second plane mirror 5b. It should be noted that, since the beam incident on the first plane 5a is deflected to the lens unit by the first plane mirror 5a and the beam directed from the lens unit 6 to the second plane mirror 5b is deflected thereby to the substrate B, the first and second mirrors 5a and 5b form an angle that is greater than 180 degrees in the X-Z plane. Optionally or alternatively, by varying the inclination of the first plane mirror 5b, the beam incident position on the object in the X-axis direction can also be changed.

The first plane mirror 5a reflects the light beam transmitted through the mask 4 to proceed in the X-axis direction so that the light beam is incident on the lens unit 6. The light beam passed through the lens unit 6 is reflected by the roof prism 7 and is incident on the lens unit 6 again. The second plane mirror 5b reflects the light beam emerging from the lens unit 6 to proceed in the Z-axis direction so that the light beam is incident on the substrate B. Thus, the light beams pass through the lens unit 6 twice and form an image of the mask pattern on the substrate B.

The lens unit 6 includes a plurality of lens elements arranged in the X-axis direction, and has a positive power as a whole.

The roof mirror 7 has a pair of mirror surfaces that are inwardly directed to form 90 degrees in the X-Y plane. The light beam emerged from the lens unit 6 is reflected by the roof mirror 7, returns to the lens unit 6 in a direction in parallel with the incident direction in the XY-plane. The roof mirror 7 is positioned near a focal point of the lens unit 6. With this arrangement, an erect image of the pattern of the mask 4 is formed on the substrate B. A right angle prism that internally reflects the light beam by surfaces forming the right angle can be used instead of the roof mirror 7.

The mask 4 and the substrate B are optically conjugate with respect to the lens unit 6. Accordingly, the image of the mask 4 is formed on the board B regardless of the position of the mirror 5.

Further, the mask 4 and the substrate holder 8 are driven by a mask-driving mechanism 14 and an object-driving mechanism 18, respectively, so that they are movable synchronously in the X-axis direction. Further, the mirror 5 is driven by a mirror driving mechanism 15 in the Z-axis direction.

The projection aligner 1 includes a first deviation detector that detects a static deviation length of the substrate B (i.e., the substrate holder 8) with respect to the mask 4, on the X-Y plane. The first deviation detector includes a first mask-position detector 24 that includes an illuminator for illuminating the mask 4 and a CCD camera for capturing the entire image of the mask 4 illuminated by the illuminator, and a first object-position detector 28 that includes an illuminator for illuminating the substrate B and a CCD camera for capturing the entire image of the substrate B illuminated by the illuminator. The wavelength and light amount of the illuminators are determined to be ones to which the photosensitive material applied on the substrate, B is not sensitive.

A controller 10 determines a moving amount of the mirror 5 based on outputs from the first mask-position detector 24 and the first object-position detector 28, and controls the mirror driving mechanism 15 to move the mirror 5 by the determined moving amounts. On the mask 4 and the substrate B, index marks are formed, respectively. The controller 10 has a function of a distance calculator that processes the images of the mask 4 and the substrate B captured by the CCD cameras, and calculates a distance from the incident position of the light beam to the index mark formed on the mask 4, and a distance from the incident position of the light beam to the index mark formed on the substrate B.

Further, the projection aligner 1 includes a second deviation detector that detects a dynamic deviation length of the substrate B (i.e., the substrate holder 8) with respect to the mask 4, on the X-Y plane, during operations of the mask-driving mechanism 14 and the object-driving mechanism 18. The second deviation detector includes a second mask-position detector 14a provided in the mask-driving mechanism 14 and a second object-position detector 18a provided in the object-driving mechanism 18.

The second mask-position detector 14a includes a linear encoder for detecting the position of the mask 4 by reading a scale formed on a movable portion of the mask-driving mechanism 14. Specifically, the mask driving mechanism 14 has a rack-and-pinion mechanism, and a linear encoder of the second mask-position detector 14a reads graduations formed on the rack portion to detect the moving amount of the mask 4 with respect to a predetermined position thereof in the X-axis direction.

The second object-position detector 18a includes a linear encoder for detecting the position of the substrate B by reading graduations formed on the movable portion of the object-driving mechanism 18. The second object-position detector 18a detects the moving amount of the substrate B in the X-axis direction with respect to a predetermined position thereof.

The controller 10 determines a moving amount of the mirror 5 based on the outputs from the second mask-position detector 14a and the second object-position detector 18a, and controls the mirror driving mechanism 15 to move the mirror 5 by the determined moving amount. The controller 10 has a function of a distance calculator that calculates the deviation length based on outputs from the linear encoders.

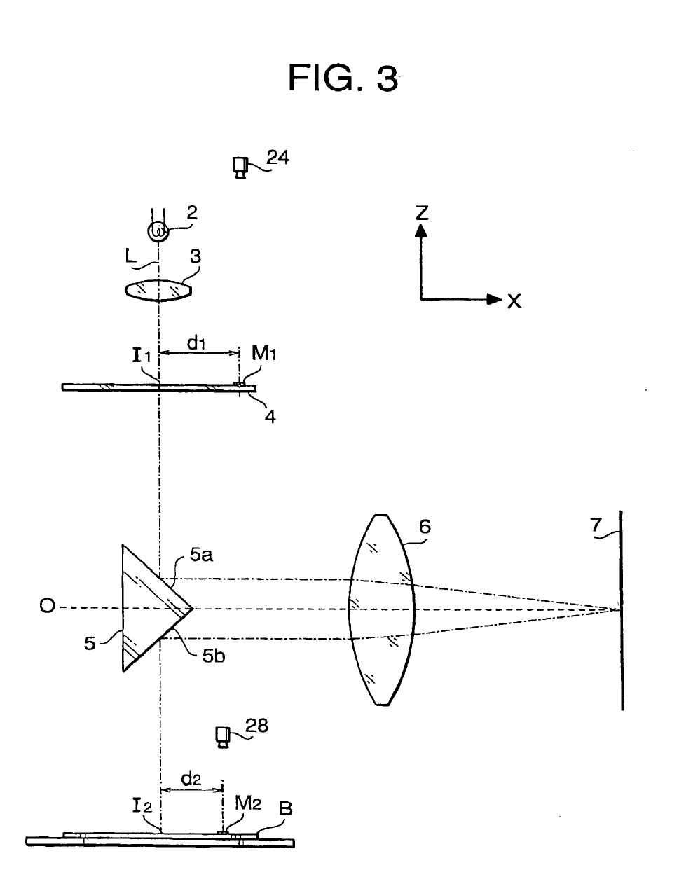

A process for compensating a deviation of alignment between the mask 4 and the substrate B will be described with reference to FIG. 2 and FIG. 3. FIG. 2 shows a condition before the compensation is applied, and FIG. 3 shows a condition after the compensation is applied.

FIG. 2 and FIG. 3 are side views of the optical system of the projection aligner 1 projected on the X-Z plane (viewed along the Y-axis). In FIG. 2 and FIG. 3, the lens unit 6 is shown as a single convex lens and the roof mirror 7 is shown as a plane mirror to simplify the drawings.

The position of the mirror 5 when it is located at the intermediate point between the mask 4 and the substrate B, as shown in FIG. 2, is defined as an origin O in the Z-axis direction. Further, the light source 2 is turned OFF during the static alignment of the mask 4 and the substrate B.

The controller 10 of the projection aligner 1 processes the image output from the first mask-position detector 24, and measures a distance d, from the incident position I₁ of the light beam L emitted form the light source on the mask 4 to an index mark M₁ formed on the mask 4. In the same manner, the controller 10 processes the image output from the first object-position detector 28, and measures a distance d₂ from the incident position I₂ of the light beam L on the substrate B to an index mark M₂ formed on the substrate B.

As shown in FIG. 2, d₁ is different from d₂. Thus, it is necessary to modify the condition so that d₁=d₂. First, the controller 10 calculates the difference Δd between the distances d₁ and d₂. When the difference Δd is not zero, the deviation between the mask 4 and the substrate B should be compensated so that d₁ is equal to d₂. The controller 10 controls the mirror driving mechanism 15 to move the mirror 5 by Δd/2 in the Z-axis direction. The mirror 5 is moved toward the mask 4 (in the positive direction of the Z-axis) if d₁>d₂, while toward the substrate B (in the negative direction of the Z-axis) if d₁<d₂.

Under the condition shown in FIG. 2, the mirror 5 is located at the origin O and d₁>d₂. Therefore, the mirror 5 is moved toward the mask 4 by Δd/2. As shown in FIG. 3, after the compensation is applied by moving the mirror 5 by Δd/2 in the Z-axis direction, the incident position I₂′ of the light beam L on the substrate B moves away from the index mark M₂ by Δd. Accordingly, the distance d₂′ from the incident position I₂′ to the index mark M₂ becomes d₂+Δd, which is equal to the distance d₁ between the incident position I₁ and the index mark M₁ on the mask 4.

After the compensation of the deviation between the mask 4 and the substrate B is applied, the light source 2 is turned on. The mask 4 is moved in the X-axis direction and the substrate B is moved in the X-axis direction synchronously with the mask 4. The pattern on the mask 4 is transferred to the substrate B with a precise alignment.

Since the alignment between the mask 4 and the substrate B can be achieved only by moving the mirror 5, it is not necessary to adjust the positions of the mask 4 and the substrate B independently. Accordingly, a single driving mechanism may be used for moving both the mask 4 and the substrate B simultaneously.

When the mask 4 and the substrate B are driven to move by respective driving mechanisms, if the driving mechanisms have relatively low driving accuracy (e.g., within a range between a few micron meters and a few tens of micron meters), the positional relationship between the mask 4 and the substrate B may not be adjusted completely only by controlling the driving mechanisms of the mask 4 and the substrate B. According to the embodiment, such an error in positional relationship can be compensated by moving the mirror 5. Further, in such a case, the mirror driving mechanism 15 is required to move the mirror 5 with the precision of 0.5 μm. The stroke of mirror driving mechanism 15 is about 10 mm and the mirror 5 is much less lighter than the mask 4 and the substrate holder 8. Therefore, a simple and low-cost mechanism can be used as the mirror driving mechanism 15, and still the mirror 5 can be driven with high precision.

The dynamic compensation which is effected to keep precision when the mask 4 and the substrate holder 8 are driven by the respective driving mechanisms will be described. The mask 4 and the substrate B may not be moved completely synchronously with each other due to driving errors of the driving mechanisms. In such a case, the controller 10 determines the deviation length between the mask 4 and the substrate B based on the outputs from the second mask-position detector 14a and the second object-position detector 18a, and controls the mirror driving mechanism 15 to move the mirror 5 in the Z-axis direction based on the deviation length.

Since the movement of the mirror 5 compensates for the deviation between the mask 4 and the board B, the mask 4 can be aligned with the substrate B even if the mask is not moved completely synchronously with the movement of the substrate due to error of precision of the mask-driving mechanism 14 and/or the substrate holder driving mechanism 18. Further, the moving amount of the mirror 5 is half the deviation length. When the mask 4 travels in advance in the positive direction of the X-axis with respect to the substrate, B, the mirror 5 is moved toward the mask 4 (in the positive direction of the Z-axis). When the substrate B travels in advance in the positive direction of the X-axis with respect to the mask 4, the mirror 5 is moved toward the substrate B (in the negative direction of the Z-axis).

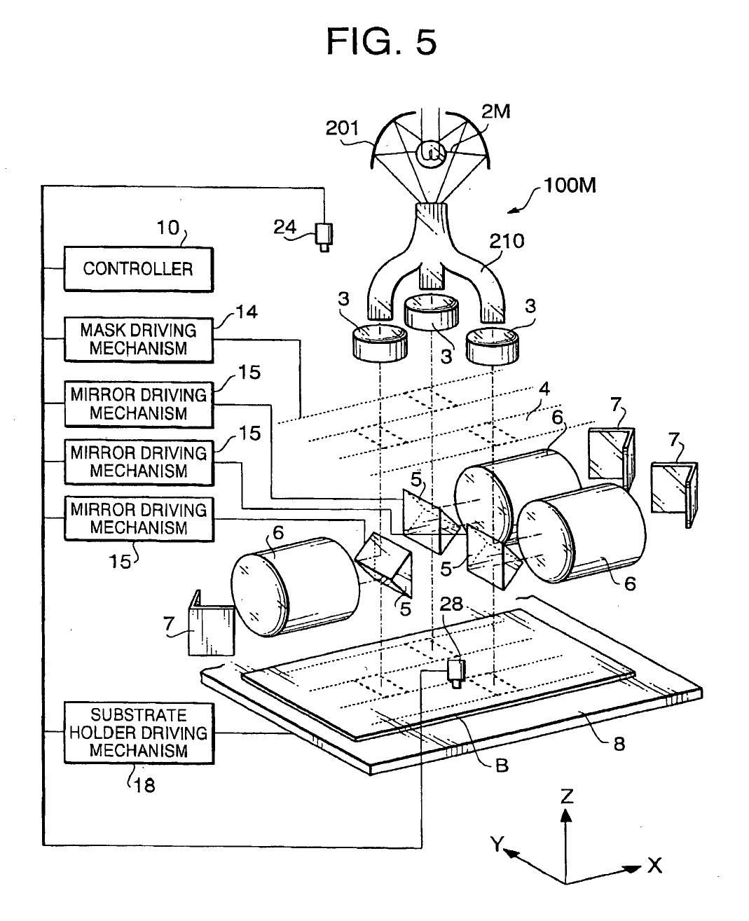

FIG. 5 shows a modification of the projection aligner described above. The structure of the modification is substantially identical to the above-described embodiment except that the light source unit 100 is replaced with another light source unit 100M.

As shown in FIG. 5, the light source unit 100M includes a single light source 2M, a parabolic mirror (or an ecliptic mirror) 201, and a beam splitting element such as an optical fiber 210. The parabolic mirror 201 collects the light emitted by the light source 2M and converges the light on an light incident surface of the optical fiber 210. The optical fiber 210 is configured to have one incident surface and a plurality of light emerging surfaces. The light incident on the light incident surface of the optical fiber 210 is split therein and the light beams having substantially the even intensity emerge out of the light emerging surfaces, respectively. The emerging beams, which are diverging beams, are collimated by the collimating lenses 3 as in the embodiment shown in FIG. 1.

It should be noted that the invention is not limited to the configurations above, and can be modified in various ways. For example, a plurality of light source units similar to the light source unit 100M may be used in a projection aligner. In such a case, the number of the light sources is less than the number of the projection optical systems.

As described above, the present invention reduces a cost of the device and increases precision because the mirror driving mechanism, which has a short stroke and drives a light-weight component, only requires high precision.

The present disclosure relates to the subject matter contained in Japanese Patent Application No. 2001-354759, filed on Nov. 20, 2001, which is expressly incorporated herein by reference in its entirety.

What is claimed is:

1. A projection aligner for transferring an image of a mask having a predetermined pattern onto an object to be exposed, said projection aligner comprising:
a light source unit that emits a plurality of light beams to the mask to illuminate predetermined areas of the mask;
a plurality of first mirrors that deflect the light beams emitted by said light source unit and passed through the predetermined areas of the mask, respectively;
a plurality of lens units, the light beams deflected by said plurality of first mirrors being incident on said plurality of lens units, respectively;
a plurality of reflectors that reflect the light beams passed through said plurality of lens units, respectively, the reflected light beams being incident on said plurality of lens units, respectively;
a plurality of second mirrors that deflect the light beams reflected by said plurality of reflectors and passed through said plurality of lens units, the light beams deflected by said plurality of second mirrors being incident on the object, the object being arranged in parallel with the mask, the plurality of light beams incident on the object forming an image on the object; and
a plurality of mirror driving mechanisms that respectively moves said plurality of first and second mirrors such that a positional relationship between a beam incident point on the mask and a beam incident point on the object with respect to each of the plurality of light beams is changed.

2. The projection aligner according to claim 1, wherein each of said plurality of lens units has a positive power.

3. The projection aligner according to claim 1, wherein said plurality of first mirrors and corresponding ones of said plurality of second mirrors are integrated in single members, respectively.

4. The projection aligner according to claim 3, comprising a plurality of triangle prism, a section of each of said plurality of triangle prisms being an isosceles right triangle, said first mirrors and the corresponding ones of said second mirrors being formed on side surfaces of said triangle prisms forming a right angle, respectively.

5. The projection aligner according to claim 1, wherein said plurality of reflectors are located in the vicinity of focal points of said plurality of lens units, respectively.

6. The projection aligner according to claim 1, wherein said plurality of reflectors include roof mirrors, each of said plurality of roof mirrors having reflection surfaces arranged perpendicular to said mask.

7. The projection aligner according to claim 1, wherein said plurality of reflectors include rectangular prisms each of which internally reflects alight beam by rectangular surfaces thereof, said rectangular surfaces being arranged perpendicular to said mask.

8. The projection aligner according to claim 1, further comprising a scanning mechanism that moves said mask and said object synchronously in a direction of an optical axis of said plurality of lens units.

9. The projection aligner according to claim 1, further comprising:
a first deviation detector that detects a deviation length of the object with respect to the mask in a direction of the optical axis of said-lens unit; and
a controller that determines moving amounts of said plurality of first and second mirrors based on an output from said first deviation detector, said controller controlling said mirror driving mechanism to move said plurality of first and second mirrors by the determined moving amounts.

10. The projection aligner according to claim 9, wherein said first deviation detector detects said deviation length by measuring a distance from the incident position of the light beam on said mask to a predetermined reference point on said mask and a distance from the incident position of the light beam on said object to another predetermined reference point on said object.

11. The projection aligner according to claim 1, further comprising;
a mask-driving mechanism for moving the mask;
an object-driving mechanism for moving the object synchronously with the mask;
a second deviation detector that detects a deviation length of the object with respect to the mask in a moving direction thereof during operations of said mask-driving mechanism and said object-driving mechanism; and
a controller that determines moving amounts of said first and second mirrors based on an output from said second deviation detector, said controller controlling said plurality of mirror driving mechanism to move said first and second mirrors by the determined moving amounts.

12. The projection aligner according to claim 1, wherein said light source unit includes a plurality of light sources that emit the plurality of light beams, respectively.

13. The projection aligner according to claim 1, wherein said light source unit includes a single light source that emit a light beam, and a beam splitting element that splits the light beam into the plurality of light beams.

14. A projection aligner for transferring an image of a mask having a predetermined pattern onto an object to be exposed, the mask and the object being substantially parallel with each other, said projection aligner comprising:
a light source unit that emits at least one light beam in a predetermined direction, the light being directed toward the object through the mask;
first and second mirrors inserted in an optical path of the at least one light beam directed from the mask to the object, an angle formed by the first and second mirrors being greater than 180 degrees;
a lens unit on which the at least one light beam reflected by the first mirror is incident;
a mirror unit that reflects the at least one light beam reflected by the first mirror and passed through the lens unit back to the lens unit, the second mirror deflecting the at least one light beam reflected by the mirror unit and passed through the lens unit to the object, an optical path of the at least one light beam from the mask to the first mirror and an optical path of the at least one light beam from the second mirror to the object being substantially parallel with each other; and
a driving mechanism that drives the deflection unit in the predetermined direction.

15. The projection aligner according to claim 14, wherein said mirror unit comprises a roof mirror.

16. A projection aligner for transferring an image of a mask having a predetermined pattern onto an object to be exposed, said projection aligner comprising:
a light source that emits a light beam to the mask to illuminate a predetermined area of the mask, the light beam passed through the mask being directed toward the object;
first mirror and second mirror inserted in an optical path of the light beam directed from the mask to the object, the first and second mirror forming an angle of greater than 180 degrees;
a lens unit, the light beam deflected by said first mirror being incident on said lens unit;
a reflector that reflects the light beam reflected by said first mirror and passed through said lens unit being reflected by said second mirror and incident on the object; and
a mirror driving mechanism that moves said first and second mirrors such that a positional relationship between a beam incident point on the mask and a beam incident point on the object is changed.

17. The projection aligner according to claim 16, wherein said mirror unit comprises a roof mirror.
